(19) United States
(12) Patent Application Publication
(10) Pub. No.: US 2024/0347803 A1
(43) Pub. Date: Oct. 17, 2024

(54) METHOD FOR SELECTIVELY RECOVERING VALUABLE METAL IN WASTE LITHIUM BATTERY

(71) Applicants: HUNAN BRUNP RECYCLING TECHNOLOGY CO., LTD., Changsha, Hunan (CN); GUANGDONG BRUNP RECYCLING TECHNOLOGY CO., LTD., Foshan, Guangdong (CN); HUNAN BRUNP EV RECYCLING CO., LTD., Changsha, Hunan (CN)

(72) Inventors: Xingen Chen, Foshan, Guangdong (CN); Ran He, Foshan, Guangdong (CN); Leijun Cao, Foshan, Guangdong (CN); Liang Li, Foshan, Guangdong (CN); Honghui Tang, Foshan, Guangdong (CN); Changdong Li, Foshan, Guangdong (CN)

(21) Appl. No.: 18/682,455

(22) PCT Filed: Apr. 28, 2022
(86) PCT No.: PCT/CN2022/090064

§ 371 Date: Feb. 9, 2024

(30) Foreign Application Priority Data
Sep. 27, 2021 (CN) 202111133678.3

(51) Int. Cl. H01M 10/54; C01D 15/08; C01G 45/02; C01G 53/00; C22B 1/06; C22B 3/22; C22B 7/00

(52) U.S. Cl. CPC H01M 10/54; C01D 15/08; C01G 45/02; C01G 53/006; C22B 1/06; C22B 3/22; C22B 7/007

(57) ABSTRACT

The present disclosure belongs to the field of lithium ion battery recovery and discloses a method for selectively recovering valuable metals in waste lithium batteries. The method includes the following steps: adding a sulfur-containing compound to waste lithium battery for calcination and water leaching to obtain lithium carbonate solution and filter residue; adding sulfuric acid and an iron-containing compound to the filter residue for leaching, performing solid-liquid separation, and taking solid phase to obtain manganese dioxide and graphite residue; extracting and reverse extracting liquid phase from the solid-liquid separation to obtain nickel cobalt sulfate solution and manganese sulfate solution. The method of the present disclosure selectively extracts lithium in waste ternary cathode materials by calcination and water leaching, and realizes selective low manganese leaching based on the principle that divalent manganese can reduce the high oxide of nickel and cobalt in the leaching stage.

### TECHNICAL FIELD

The present disclosure belongs to the technical field of lithium ion battery recovery, specifically relates to a method for selectively recovering valuable metals in waste lithium batteries.

### BACKGROUND

Lithium battery recycling has achieved rapid development in China in recent years. The ternary precursors and lithium salts are prepared from waste ternary lithium batteries after subjecting cell to disassembling, shredding, leaching, copper removal, iron and aluminum removal, calcium and magnesium removal, extraction and co-precipitation, which has achieved better economic benefits and formed a relatively large scale industry.

At present, one or a mixture of more of sulfuric acid system, sodium sulfite, hydrogen peroxide and sodium thiosulfate are widely used as reducing agents to transfer all valuable metals in raw materials into sulfuric acid system, and the leaching rate of nickel, cobalt and manganese can reach to 99% or more. This non selective leaching also brings a large number of impurities into the system, which greatly increasing the difficulty of subsequent impurity removal treatment.

In the recovery of ternary battery, the valuable metals mainly recovered are nickel, cobalt and lithium. At present, in the common hydrometallurgical process of using extractant to separate metal nickel, cobalt and manganese, the leaching of manganese increases the consumption of alkali and sulfuric acid solution for extraction and increases the extraction flux. According to statistics, reduction of manganese extraction for one time saves about 10000 RMB per ton of manganese.

Therefore, it is urgent to develop a non-manganese-leaching process to solve the existing process problems, so as to realize a technique with the selective low manganese leaching, and this reducing agent having the advantages of mild service conditions, easy transportation and preservation and high conversion rate at the same time.

### SUMMARY

The invention aims to solve at least one of the above-described technical problems existing in prior art. Therefore, the invention provides a method for selectively recovering valuable metals in waste lithium batteries. The method can selectively leach a small amount of manganese metal of ternary batteries first, and does not introduce reducing agents such as hydrogen peroxide and sodium sulfite with lower utilization in the leaching process, so as to solve the process problems such as lower utilization of the reducing agent, troublesome storage and transportation, foam production and so on in low acid leaching. At the same time, due to the introduction of iron-containing compounds, the impurity aluminum in battery powder preferentially reacts with iron ions, inhibits the reaction between aluminum and acid, avoids the problem of hydrogen production by reaction, and greatly ensures the safety of production.

In order to achieve the above purpose, the invention adopts the following technical solutions.

A method for selectively recovering valuable metals in waste lithium batteries, comprises the following steps:
(1) adding a sulfur-containing compound to waste lithium battery for calcination, and performing water leaching to obtain lithium carbonate solution and filter residue;
(2) adding sulfuric acid and an iron-containing compound to the filter residue for leaching, performing solid-liquid separation, and taking solid phase to obtain manganese dioxide and graphite residue; and
(3) extracting and reverse extracting liquid phase from the solid-liquid separation to obtain nickel and cobalt sulfate solution and manganese sulfate solution wherein the sulfur-containing compound is one or two of sulfate or sulfide salt.

Preferably, in step (1), a temperature for the calcination is 350-600° C.

Preferably, the sulfate is one or two of ammonium sulfate or sodium sulfate; the sulfide salt is one or two of sodium sulfide or ammonium hydrogen sulfide solution.

Preferably, in step (1), a temperature for the water leaching is 50-90° C., and a liquid-solid ratio for the water leaching is (8-12):1 g/ml.

Preferably, in step (1), the filter residue is a high valence oxide of nickel, cobalt and manganese.

Preferably, in step (2), pH of the sulfuric acid is 1-2.

Preferably, in step (2), a temperature for the leaching is 80° C.-110° C.

Preferably, in step (2), the iron-containing compound is at least one of a divalent iron compound or a trivalent iron compound.

Further preferably, the divalent iron compound is one of ferrous sulfate or ferrous chloride; and the ferric compound is one of ferric sulfate or ferric chloride.

Preferably, in step (2), concentration of the divalent or trivalent iron compound is 10-20 g/L.

Preferably, in step (2), a mass ratio of the filter residue to the iron-containing compound in the leaching process is 10:(0.5-2).

Preferably, in step (2), pH for the leaching is 0.5-2 and leaching time is 8-20 hours.

Preferably, before the extracting, step (3) further comprises adding iron powder to the liquid phase after solid-liquid separation in step (2) for reduction reaction; performing solid-liquid separation, adding the filter residue in step (1) to liquid phase for reaction; performing solid-liquid separation, adding sodium fluoride and calcium salt to liquid phase for reaction; performing solid-liquid separation, adding aluminum sulfate and calcium salt to liquid phase for reaction to obtain nickel cobalt manganese sulfate solution.

Further preferably, the calcium salt is one or two of calcium sulfate or calcium carbonate.

Further preferably, after the filter residue in step (1) is added to the liquid phase for reaction, step (3) further comprises adjusting pH to acidity.

More preferably, the pH adjustment to acidity is to adjust the pH to 3.5-4.5.

Preferably, in step (3), the reagent used for the extracting is at least one of P204 or P507.

The reaction mechanism of step (2) is as follows:

2Ni_{X}Co_{Y}Mn_{(1-x-y)}O₂+4H₂SO₄+2FeSO₄═Fe₂(SO₄)₃+2Ni_{X}Co_{Y}Mn_{(1-X-Y)}SO₄+H₂O Formula (I);

(x+y−0.5)MnSO₄+NiₓCo_{y}Mn_{(1-x-y)}O₂+H₂SO₄=0.5MnO₂+xNiSO₄+yCoSO₄+H₂O Formula (II);

2Al+2Cu+5Fe₂(SO₄)₃=10FeSO₄+2CuSO₄+Al₂(SO₄)₃ Formula (III).

When iron compound is added as reducing agent, the mechanism is as shown in Formula (I). After the reaction has progressed for a period of time, the reaction conditions are controlled to convert divalent manganese into high valent manganese. The mechanism is as shown in Formula (II). The trivalent iron generated by the reaction or directly introduced reacts with a small amount of aluminum and copper in the battery powder. The mechanism is as shown in Formula (III). As the oxidability of high valent nickel and cobalt is much greater than that of manganese dioxide, the manganese dioxide formed in the pH environment of this reaction will not be dissolved in the follow-up.

The reaction mechanism of step (3) is as follows.

Extraction is to transfer a compound from one solvent to another by utilizing the difference of solubility or distribution coefficient of the compound in two immiscible (or slightly soluble) solvents. Manganese ions react with the extractant to form an extract that is insoluble in an aqueous phase but soluble in an organic phase, so that manganese is transferred from the aqueous phase to the organic phase. Then, sulfuric acid is mixed with the organic phase to protonate the extractant and disintegrates the extract. Manganese ions return to the aqueous phase from the organic phase to realize reverse extraction.

2MeLn+nH₂SO₄=Me₂(SO₄)n+2n(HL). Reaction formula:

The present invention has the following beneficial effects.

The method of the invention first selectively extracts lithium, so that manganese can be extracted separately in the follow-up. A compound or a mixture of iron is introduced into the leaching stage as a reducing agent to safely and efficiently leach lithium cobaltate, and nickel cobalt metal elements in ternary battery powder. At the same time, manganese is not leached. Manganese metal element is effectively separated, and manganese is selectively extracted in the later stage, which eliminates the nickel and cobalt flux in the extraction stage, reduces the manganese flux in the extraction stage, and achieves the selective recovery of the metal elements of the cathode material of the waste lithium battery. Also, it provides a method for recovering nickel and cobalt metals that is safe, and of low cost, no risk of raw material transportation and storage, and mild reaction process.

### BRIEF DESCRIPTION OF DRAWINGS

FIG. 1 is a process flow diagram of Example 1 and Example 2 of the present invention;

FIG. 2 shows the extraction sequence of metals by P507 at different pH; and

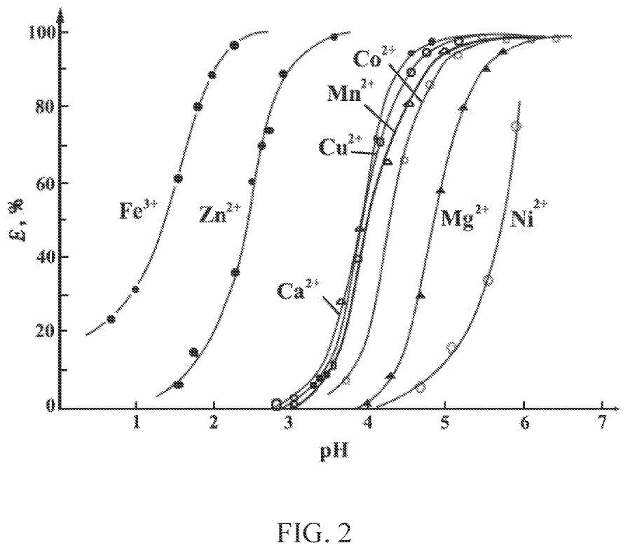

FIG. 3 shows the extraction sequence of metals by P204 at different pH.

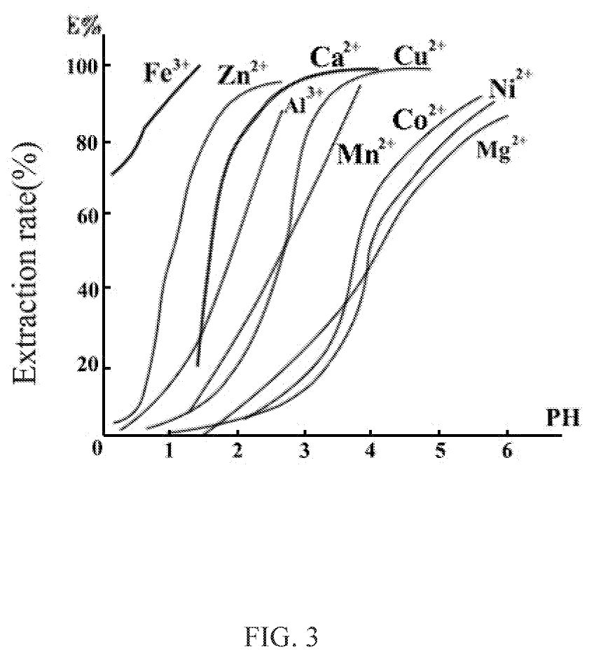

### DETAILED DESCRIPTION

For a thorough understanding of the present invention, the preferred embodiments of the present invention will be described below in combination with examples to further illustrate the characteristics and advantages of the present invention. Any changes or modifications without departing from the purpose of the present invention can be understood by those skilled in the art. The scope of protection of the invention is determined by the scope of the claims.

### Example 1

The method for selectively recovering valuable metals in waste lithium batteries of this example comprised the following steps:
(1) after adding ammonium sulfate to the waste lithium battery and mixing, it was calcinated at 500° C. to obtain cathode material powder of the battery, and then water leaching was carried out at a temperature of 50° C. (solid-liquid ratio for the water leaching was 10:1 g/ml) to obtain leaching solution and filter residue;
(2) 1 ton of the above filter residue powder, with nickel content of 14.8%, cobalt content of 19.9% and manganese content of 19.3%, was pulped, ferrous sulfate was added to 20 g/L, constant volume was determined to 5 m³, sulfuric acid of 98% mass fraction was added to adjust pH to 0.5, heated to 70° C., reacted for 12 h, and filtered to obtain filtrate and filter residue (manganese dioxide residue and graphite residue);
(3) 80 kg iron powder was added into the filtrate of step (2) for reduction to obtain sponge copper and a copper-removed solution;
(4) the copper-removed solution was heated to 80° C., 100 kg of filter residue (nickel content 35.2%, cobalt content 8.32%, and manganese content 8.3%) after calcination in step (2) was added and mixed for reaction, pH was adjusted to 3.5-4.5, and filtered to obtain iron and aluminum residue and filtrate;
(5) 200 kg sodium fluoride was added to the filtrate of step (4) for magnesium removal, 850 kg calcium sulfate was added for fluorine removal, 850 kg aluminum sulfide and calcium carbonate were added for precipitation to remove fluorine, iron and aluminum, and finally P204 was added for extraction and calcium removal to obtain calcium and magnesium residue, fluorine-containing residue (calcium fluoride) and filtrate; and
(6) P507 was added to the filtrate of step (5) for extraction to obtain nickel and cobalt sulfate solution and manganese sulfate solution; the nickel and cobalt sulfate solution was evaporated and recrystallized to obtain qualified nickel and cobalt sulfate binary crystals; and the manganese extraction solution was processed to obtain battery-grade manganese sulfate crystal.

The manganese dioxide residue in step (1) was separated and dried to obtain manganese dioxide with a dry weight of about 250 kg, in which nickel content was 0.02% and cobalt content was 0.03%. The dry weight of graphite residue was about 280 kg, with nickel content of 0.01%, cobalt content of 0.02% and manganese content of 4.72%.

A total of 1700 kg nickel and cobalt sulfate crystal was obtained in step (6), with nickel content of 8.3%, and cobalt content of 11.3%, and 100 kg manganese sulfate crystal with manganese content of 31.64%.

The reaction mechanism of step (2) is as follows:

2Ni_{X}Co_{Y}Mn_{(1-x-y)}O₂+4H₂SO₄+2FeSO₄═Fe₂(SO₄)₃+2Ni_{X}Co_{Y}Mn_{(1-X-Y)}SO₄+H₂O Formula (I);

(x+y−0.5)MnSO₄+NiₓCo_{y}Mn_{(1-x-y)}O₂+H₂SO₄=0.5MnO₂+xNiSO₄+yCoSO₄+H₂O Formula (II);

2Al+2Cu+5Fe₂(SO₄)₃=10FeSO₄+2CuSO₄+Al₂(SO₄)₃ Formula (III).

### Example 2

The method for selectively recovering valuable metals in waste lithium batteries of this example comprised the following steps:
(1) after adding ammonium sulfate to the waste lithium battery and mixing, it was calcinated at 500° C. to obtain battery cathode material powder, and then water leaching was carried out at a temperature of 50° C. (solid-liquid ratio for the water leaching is 10:1 g/ml) to obtain leaching solution and filter residue;
(2) 1 ton of the above filter residue powder, with lithium content of 3.8%, nickel content of 28.8%, cobalt content of 17.9% and manganese content of 11.3%, was pulped, ferrous sulfate was added to 10 g/L, ferric sulfate was added to 10 g/L, constant volume was determined to 5 m³, sulfuric acid of 98% mass fraction was added to adjust pH to 0.5, heated to 70° C., reacted for 12 h, and filtered to obtain filtrate and filter residue (manganese dioxide residue and graphite residue);
(3) 80 kg iron powder was added to the filtrate of step (2) for reduction reaction to obtain sponge copper and copper-removed solution;
(4) the copper-removed solution was heated to 80° C., 100 kg of filter residue (nickel content 28.8%, cobalt content 17.9%, and manganese content 11.3%) after calcination in step (2) was added and mixed for reaction, pH was adjusted to 3.5-4.5, and filtered to obtain iron and aluminum residue and filtrate;
(5) 200 kg sodium fluoride was added to the filtrate of step (4) for magnesium removal, 800 kg calcium sulfate was added for fluorine removal, 1000 kg aluminum sulfide and calcium carbonate was added for precipitation to remove fluorine and iron and aluminum, and finally P204 was added for extraction and calcium removal to obtain calcium and magnesium residue, fluorine-containing residue (calcium fluoride) and filtrate; and
(6) P507 was added to the filtrate of step (5) for extraction to obtain nickel and cobalt sulfate solution and manganese sulfate solution; the nickel and cobalt sulfate solution was evaporated and recrystallized to obtain qualified nickel and cobalt sulfate binary crystals; and the manganese extraction solution was processed to obtain battery-grade manganese sulfate crystals.

The manganese dioxide residue in step (1) was separated and dried to obtain manganese dioxide with a dry weight of about 150 kg, in which nickel content was 0.02% and cobalt content was 0.03%. The dry weight of graphite residue was about 280 kg, with nickel content of 0.01%, cobalt content of 0.02% and manganese content of 2.72%.

In step (6), 2300 kg of nickel and cobalt sulfate crystal is obtained, with nickel content of 15.0%, and cobalt content of 3.54%, and 50 kg of manganese sulfate crystal with manganese content of 31.7%.

The reaction mechanism is as follows:

2Ni_{X}Co_{Y}Mn_{(1-x-y)}O₂+4H₂SO₄+2FeSO₄═Fe₂(SO₄)₃+2Ni_{X}Co_{Y}Mn_{(1-X-Y)}SO₄+H₂O Formula (I);

(x+y−0.5)MnSO₄+NiₓCo_{y}Mn_{(1-x-y)}O₂+H₂SO₄=0.5MnO₂+xNiSO₄+yCoSO₄+H₂O Formula (II);

2Al+2Cu+5Fe₂(SO₄)₃=10FeSO₄+2CuSO₄+Al₂(SO₄)₃ Formula (III).

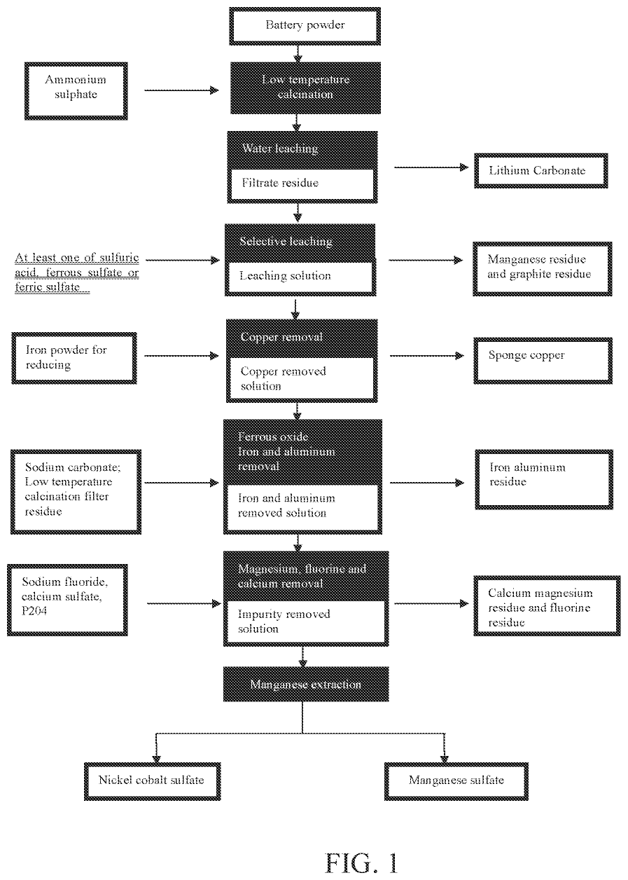

FIG. 1 was a process flow diagram of Examples 1 and 2 (the black box indicates the process of processing, and the white box indicates the substance obtained or added, for example, pretreatment was performed on the battery to obtain battery powder).

### Comparative Example 1

The method for selectively recovering valuable metals in waste lithium batteries of this comparative example comprised the following steps:
(1) the waste lithium batteries were calcinated at 500° C. to obtain cathode material powder of battery;
(2) 1 ton of the above cathode material powder, with lithium content of 4.2%, nickel content of 14.8%, cobalt content of 19.9% and manganese content of 19.3%, was pulped, hydrogen peroxide and sodium sulfite were added, constant volume was determined to 5 m³, sulfuric acid of 98% mass fraction was added to adjust pH to 1, heated to 80° C., reacted for 12 h, and filtered to obtain graphite residue and filtrate;
(3) 80 kg iron powder was added into the filtrate for reduction reaction to obtain sponge copper and a copper-removed solution;
(4) Hydrogen peroxide was added to the filtrate, pH was adjusted, and filtration was performed to obtain iron and aluminum residue and filtrate;
(5) P507 was added to the filtrate for extraction to obtain nickel and cobalt sulfate solution and manganese sulfate solution; and
(6) Liquid alkali was added to the nickel and cobalt sulfate solution to precipitate nickel and cobalt; after impurity removal from the filtrate, lithium was precipitated with sodium carbonate; the manganese sulfate solution was treated to obtain battery-grade manganese sulfate crystal.

The manganese dioxide residue in step (1) was separated and dried to obtain manganese dioxide with a dry weight of about 150 kg, in which nickel content was 0.02% and cobalt content was 0.03%. The dry weight of graphite residue was about 280 kg, with nickel content of 0.01%, cobalt content of 0.02% and manganese content of 2.72%.

A total of 2300 kg nickel and cobalt sulfate crystal was obtained in step (6), with nickel content of 15.0%, and cobalt content of 3.54%, and 50 kg manganese sulfate crystal with manganese content of 31.7%.

The elemental composition of graphite residue in Examples 1-2 and Comparative Example 1 was detected, and the results were shown in Table 1:

TABLE 1

| | | | | | Mn recovery |
|---|---|---|---|---|---|
| Elements | Li(%) | Ni + Co(%) | Mn(%) | C(%) | rate (%) |
| Example 1 | 0.01 | 0.08 | 32.3 | 50 | 88.4 |
| Example 2 | 0.01 | 0.08 | 25.5 | 60 | 92.8 |
| Comparative | 0.2 | 0.3 | 0.4 | 80 | 0.01 |
| Example 1 | | | | | |

It can be seen from table 1 that when the non-manganese-leaching process used in the invention was adopted, 88.4% or more of the manganese was separated with the graphite residue, saving auxiliary material input and equipment loss in the subsequent process effectively. At the same time, due to the first extraction of lithium, the method of the invention also reduced the loss caused by lithium entering the graphite residue and effectively improved the metal recovery rate.

The elemental composition of the leaching solution in step (2) of Examples 1-2 and Comparative Example 1 was detected, and the results were shown in Table 2:

TABLE 2

| Elements | Li(g/L) | Ni + Co(g/L) | Mn(g/L) | Fe2 + Fe3(g/L) |
|---|---|---|---|---|
| Example 1 | 0.02 | 69.4 | 4.6 | 20 |
| Example 2 | 0.02 | 69.4 | 3.7 | 22 |
| Comparative | 8.4 | 93.4 | 38.6 | 2.5 |
| Example 1 | | | | |

The invention adopted the preferential lithium extraction process by water leaching, and lithium was preferentially extracted before leaching, which effectively simplified the process flow and reduced metal loss.

The elemental composition of leaching iron and aluminum residue in Examples 1-2 and Comparative Example 1 was detected. The results were shown in Table 3:

TABLE 3
element content of iron and aluminum residue

| Elements | Ni(%) | Co(%) | Mn(%) | Fe(%) | Al(%) | Cu(%) |
|---|---|---|---|---|---|---|
| Example 1 | 0.02 | 0.03 | 0.04 | 30 | 5.0 | 0.01 |
| Example 2 | 0.02 | 0.03 | 0.04 | 30 | 5 | 0.01 |
| Comparative | 0.02 | 0.03 | 0.04 | 15 | 7.0 | 0.01 |
| Example 1 | | | | | | |

It can be seen from table 3 that the iron and aluminum content of Examples 1-2 was much higher than that of the filter residue added with sodium sulfite in Comparative Example 1, which was due to the introduction of a large amount of iron element in the reduction process.

The components of nickel and cobalt sulfate solution or manganese sulfate solution in Examples 1-2 and Comparative Example 1 were detected. The results were shown in Table 4 and Table 5:

TABLE 4
elemental composition of nickel and cobalt sulfate solution

| Elements | Ni(g/L) | Co(g/L) | Mn(g/L) | Fe(mg/L) | Al(mg/L) | Cu(mg/L) |
|---|---|---|---|---|---|---|
| Example 1 | 31 | 39 | 0.2 | 2 | 3 | 1 |
| Example 2 | 58 | 36 | 0.2 | 2 | 3 | 1 |
| Comparative | 31 | 39 | 38 | 2 | 3 | 1 |
| Example 1 | | | | | | |

TABLE 5
content and composition of manganese sulfate

| Elements | Ni(%) | Co(%) | Mn(%) | Fe(%) | Al(%) | Cu(%) |
|---|---|---|---|---|---|---|
| Example 1 | 0.02 | 0.02 | 32.1 | 0.01 | — | — |
| Example 2 | 0.02 | 0.02 | 32.1 | 0.01 | — | — |
| Comparative | None | None | None | None | None | No |
| Example 1 | | | | | | product |

The recovery rates of the elements in Examples 1-2 and Comparative Example 1 were shown in Table 6:

TABLE 6

| Elements | Ni | Co | Mn | Li | Fe | Cu |
|---|---|---|---|---|---|---|
| Example 1 | 99.49% | 99.2% | 98.2% | 95.35% | 99.8% | 99.85% |
| Example 2 | 99.49% | 99.2% | 98.2% | 95.85% | 99.8% | 99.85% |
| Comparative | 97.50% | 96.0% | 95.2% | 94.2% | 99.2% | 99.3% |
| Example 1 | | | | | | |

The invention adopted the preferential lithium extraction process by water leaching, and lithium was preferentially extracted before leaching, which can improve the recovery rate of lithium; and then used the non-manganese-leaching process to further improve the recovery rate of nickel, cobalt and manganese.

The cost analysis of each element in Examples 1-2 and in Comparative Example 1 were shown in Table 7:

TABLE 7

| | | | Ni + Co + |
|---|---|---|---|
| process/recovery rate | Li(%) | process/recovery rate | Mn |
| lithium extraction by | 95.35 | Single manganese | 12.6 |
| water leaching | | extraction flux | |
| conventional process | 94.20 | Total extraction flux | 350 |
| lithium recovery rate | 1.1% | Reduced extraction flux | 96.4% |

It can be seen from table 7 that the recovery rate of lithium was increased by 1.1%, while process entrainment was reduced, a lot of energy consumption was saved and production capacity was improved. By adopting the selective leaching process, 88% or more of manganese was selectively and preferentially separated. Taking the common 523 series as an example, each ton of battery powder contains 350 kg of nickel cobalt manganese metal. For the single manganese extraction process, the extraction flux was only 12.6. Based on the extraction cost of 3000 RMB per ton of battery, at least 2800 RMB/ton can be saved, which has obvious advantages, especially for the subsequent recovery of high nickel materials.

The above examples are the preferred embodiments of the invention, but the embodiments of the invention are not limited by the above examples. Any other changes, modifications and simplification without departing from the spiritual essence and principle of the invention shall be deemed as equivalent replaced modes, which are included in the protection scope of the invention.

1. A method for selectively recovering valuable metals in waste lithium battery, comprising the following steps:
(1) adding a sulfur-containing compound to waste lithium battery for calcination, and performing water leaching to obtain lithium carbonate solution and filter residue;
(2) adding sulfuric acid and an iron-containing compound to the filter residue for leaching, performing solid-liquid separation, and taking solid phase to obtain manganese dioxide and graphite residue; and
(3) extracting and reverse extracting liquid phase from the solid-liquid separation to obtain nickel and cobalt sulfate solution and manganese sulfate solution, wherein the sulfur-containing compound is one or two of sulfate or sulfide salt.

2. The method according to claim 1, wherein the sulfate is one or two of ammonium sulfate or sodium sulfate; and the sulfide salt is one or two of sodium sulfide or ammonium hydrogen sulfide solution.

3. The method according to claim 1, wherein in step (1), temperature for the water leaching is 50-90° C., and liquid-solid ratio for the water leaching is (8-12):1.

4. The method according to claim 1, wherein in step (2), the iron-containing compound is at least one of a divalent iron compound or a trivalent iron compound.

5. The method according to claim 4, wherein the divalent iron compound is one of ferrous sulfate or ferrous chloride; and the trivalent iron compound is one of ferric sulfate or ferric chloride.

6. The method according to claim 1, wherein in step (2), pH for the leaching is 0.5-2, leaching time is 10-20 hours, and a temperature for the leaching is 60-90° C.; and a mass ratio of the filter residue to the iron-containing compound in the leaching process is 10:(0.5-2).

7. The method according to claim 1, wherein before the extracting, step (3) further comprises adding iron powder to liquid phase after solid-liquid separation in step (2) for reduction reaction; performing solid-liquid separation, adding the filter residue in step (1) to liquid phase for reaction; performing solid-liquid separation, adding sodium fluoride and calcium salt to liquid phase for reaction; performing solid-liquid separation, adding aluminum sulfate and calcium salt to liquid phase for reaction to obtain nickel cobalt manganese sulfate solution.

8. The method according to claim 7, wherein the calcium salt is one or two of calcium sulfate or calcium carbonate.

9. The method according to claim 7, wherein after the filter residue in step (1) is added to the liquid phase, step (3) further comprises adjusting pH to acidity.

10. The method according to claim 1, wherein in step (3), the reagent used for the extracting is at least one of P204 or P507.
